(19) United States
(12) Patent Application Publication
(10) Pub. No.: US 2006/0229853 A1
(43) Pub. Date: Oct. 12, 2006

(54) Apparatus and method for data modeling business logic

(75) Inventor: Luke William Evans, West Vancouver (CA)

Correspondence Address: COOLEY GODWARD, LLP, 3000 EL CAMINO REAL, 5 PALO ALTO SQUARE, PALO ALTO, CA, 94306, US

(73) Assignee: Business Objects, S.A., Levallois-Perret (FR)

(21) Appl. No.: 11/102,613

(22) Filed: Apr. 7, 2005

(51) Int. Cl. G06F 17/10

(52) U.S. Cl. 703/2

(57) ABSTRACT

A computer readable medium storing executable instructions to define a data modeling system include executable instructions to specify named modular semantic transformation objects that contain a function, a type and metadata. Executable instructions are used to combine modular semantic transformation objects, as permitted based on type and metadata constraints, in order to create composite functionality represented by a composite modular semantic transformation object.

### CROSS-REFERENCES TO RELATED APPLICATIONS

This application is related to the following concurrently filed, commonly owned patent applications, each of which is incorporated by reference herein:

Apparatus and Method for Deterministically Constructing a Text Question for Application to a Data Source, Ser. No. ______, filed Apr. 7, 2005;

Apparatus and Method for Utilizing Sentence Component Metadata to Create Database Queries, Ser. No. ______, filed Apr. 7, 2005; and

Apparatus and Method for Constructing Complex Database Query Statements Based on Business Analysis Comparators, Ser. No. ______, filed Apr. 7, 2005.

### BRIEF DESCRIPTION OF THE INVENTION

This invention relates generally to information processing. More particularly, this invention relates to a technique for data modeling business logic to enhance Business Intelligence applications.

### BACKGROUND OF THE INVENTION

Business Intelligence (BI) applications are generally based on an architectural level, rather than a logic or data modeling level. The architectural level relies upon a server architecture that only offers a coarse interpretation of data logic. The focus of the architectural level is on an efficient flow of data between servers, not on modeling the transformation and flow of the data specifically. In contrast, the logic, or data modeling, level is focused on data and is not concerned with the larger software architecture, such as the I/O and the sequencing of events. Current Business Intelligence solutions do not focus on the formal modeling of logic or data.

In order to most effectively model specific data transformations, a solution needs to provide three things. First, it needs a focus on the data logic, while being readily integratable within server based solutions. Second, it needs a capacity to evaluate a broad range of expressions (including strong typing) and maintaining precision within the data definition. Third, it needs to provide reusable logic (e.g., based on strong typing, lazy evaluation, and readily combinable functional units).

Traditional BI applications are implemented using imperative programming. Imperative programming is based on a procedural or object oriented programming language. These solutions are limited by statefulness, and unlike a functional programming approach to data modeling, these traditional solutions lack portability, composability, and reusability.

Functional programming languages have a strong history of use within academic settings, but have not typically been applied to commercial programming projects and have not otherwise been developed to the degree required for commercial use. Tools have not been available to enable the use of functional programming languages for commercial development projects, such as visual development environments, comprehensive repository systems, or extensive interpretative tools.

Proposals to incorporate functional programming within the context of commercial applications have been limited in scope and have not focused on business logic. Functional languages, such as Erlang, have been used in telecommunications switching system products (Ericsson) (http://homepages.inf.ed.ac.uk/wadler/realworld/erlang.html). Functional languages have also been used for processing natural language queries and partial evaluation of the rule language CRL (used to express constraints when scheduling air crews). These applications use the strengths of functional programming languages to solve very specific problems, rather than leveraging the strengths of functional programming to shape a larger approach to a series of inter-related BI problems. In particular, there are no applications to generate BI data models.

When systematically applied, data modeling provides a focus on data transformation to solve a series of Business Intelligence problems. The definitional precision ensures the reliability of the data during compositional modeling and enables a modular approach that facilitates reuse and extensibility. Lazy evaluation allows the compositional modeling for large data sets without expensive processing.

A focus on the architectural level of the Business Intelligence solution is important to create the scalable architectural context for data handling, but it neglects the very data (and its transformation) that is at the core of a Business Intelligence application's challenge of providing data access and analysis to help users make effective business decisions. A solution focusing on data and data transformation, which can be integrated within an existing server architecture, and that has the capacity to maintain precise data definitions and reuse of logic, can provide a more subtle and scalable approach to handling data and data transformations than have historically been provided in the Business Intelligence space.

There are no existing approaches to describe and reuse BI logic across different applications. Existing approaches tend to be service based, such as ‘bus’ architectures that focus on the server infrastructure. These types of solution provide a ‘physical’ framework, where servers and their services can be discovered and managed effectively within a more organic, reliable and scalable system. While this type of solution deals efficiently with the unit of execution of different major faculties in a BI infrastructure, it does not focus on the logic of BI itself. This architectural approach results in products that are unable to share or re-use data flows/treatments or analyses and have no way to save/load interesting data flows independently of whole saved files (reports or applications). There is no way to move around the logic in a way that is stateless, more granular than web-services, and capable of supporting parallel processing.

To advance the state of BI, it is clear that another paradigm is required. This paradigm needs to act as a logical framework, demonstrating similar reliability, reusability and correctness as an architectural approach, but dealing with ‘units of business logic’ (rather than a server infrastructure). In order to create such a logic (or data modeling) centric solution, many of the programming approaches and assumptions that underlie the architectural approach need to be reconsidered.

### SUMMARY OF THE INVENTION

The invention includes a computer readable medium storing executable instructions to define a data modeling system. The executable instructions specify named modular semantic transformation objects that contain a function, a type and metadata. Executable instructions are used to combine modular semantic transformation objects, as permitted based on type and metadata constraints, in order to create composite functionality represented by a composite modular semantic transformation object.

The invention provides a systematic approach to BI problem-solving that offers definitional precision, leverages lazy evaluation, and provides reusable logic based on functional units that are readily combinable and easy to visually model. The invention introduces a robust approach to data modeling and transformation based on the strengths of a functional programming language.

A lack of focus on data modeling business logic was identified as a limitation in current Business Intelligence offerings. A focus on data modeling and the ability to manipulate data within the context of specific business logic are aspects of the invention. The new paradigm associated with the invention is used to augment the architectural approach, rather than replace it. The invention is optimized for the purpose of handling BI transformations, while relying upon existing applications for I/O and the sequencing of events. The separation of business logic from application logic was already well understood and generally accepted as a best practice, so this is a natural symmetry break.

The modular semantic transformation objects (MSTOs) of the invention have strength based on the modularity of the objects that are combined together within a context of strongly typed data precision to transform the meaning of data as it passes through a data flow or model. The MSTOs provide reusable logic that can be applied to data modeling for BI. The lazy evaluation and statelessness of the MSTOs is also a significant factor in their effectiveness for creating reusable business logic. In order to implement an effective MSTO based solution, design oriented tools and integration oriented tools have been developed. The design oriented tools include a proprietary functional programming language, visual integrated development environment (IDE), and compilation processes for creating native MSTOs. The integration tools include APIs and compilation processes that support integrating MSTOs defined using functional programming languages and producing code that can be integrated within imperative programming languages on the fly, thus creating MSTOs that support the data modeling needs of container applications.

### BRIEF DESCRIPTION OF THE FIGURES

The invention is more fully appreciated in connection with the following detailed description taken in conjunction with the accompanying drawings, in which:

FIG. 1 illustrates the composition of a MSTO that adds two values together to produce a third value in accordance with an embodiment of the invention.

FIG. 2 generally corresponds to FIG. 1, but illustrates how visual components are displayed for the MSTO in FIG. 1.

FIG. 3 generally corresponds to FIG. 2, but illustrates the MSTO with specific input and output values as depicted within an exemplary UI.

FIG. 4 illustrates the combination of three MSTOs to form a simple data flow and the process by which the three MSTOs can be saved to create a new composite fourth MSTO that combines the functions and type information from the first three MSTOs.

FIG. 5 generally corresponds to FIG. 4, but illustrates the combination of MSTOs with specific input and output values as depicted within an exemplary UI.

FIG. 6 illustrates how a combination of MSTOs exists as a data flow within a workspace, can be saved to a repository, or accessed by another application using an API.

FIG. 7 illustrates an architecture demonstrating how a workspace fits in with other components and how within a workspace MSTOs exist at different levels of permanence.

FIG. 8 illustrates components configured in accordance with an embodiment of the invention to compile and store MSTOs.

FIG. 9 illustrates front end compilation and manipulation of MSTOs in accordance with an embodiment of the invention.

FIG. 10 illustrates classes within a Java or .NET process and how they connect to the workspace and compilation.

Like reference numerals refer to corresponding parts throughout the several views of the drawings.

### DETAILED DESCRIPTION OF THE INVENTION

The invention is disclosed in connection with the following definitions.

A Modular Semantic Transformation Object (MSTO) is a data transformation block that consists of a function, typing information, and metadata (such as, category information, hints, and descriptions). Every MSTO has an input and produces an output. MSTOs enable the modeling of data flow. Because they are strongly typed, MSTO definitional precision provides validation of the data flow.

Gem is another name for a MSTO. The term Gem is used in connection with API code and in reference to a “Gem Cutter”, which is a tool for creating and modifying MSTOs.

A Functional Programming Language is a kind of declarative programming language, generally based on typed lambda calculus with constraints. A functional programming language consists of function definitions and an expression whose value is output as the program's result.

An Imperative Programming Language is a programming language in a paradigm that describes computation in terms of a program state and sequential statements that change the program state.

A Lazy Evaluation Strategy is an evaluation strategy where any function only explores enough of its arguments in order to produce a result. Its arguments may be infinite data structures (e.g., lists) of values, the components of which are only evaluated as needed. Lazy evaluation can provide high level performance benefits, particularly when dealing with large or infinite data structures. Eager evaluation (also known as strict evaluation), which is the opposite of lazy evaluation, is the normal evaluation behavior in most programming languages. A lazy evaluation strategy is essential for high level compositional models to avoid inefficiencies building up because too much processing occurs at every step. Often this processing is hidden from the composer of new functions so the performance implications of the new functions are not clear.

Crystal Analytic Language (CAL) is a proprietary functional programming language utilized by Business Objects Americas, San Jose, Calif. CAL is developed to support specific transformations required by Business Intelligence and is designed to be hosted by managed code platforms (e.g., Java and .Net). CAL uses lazy evaluation and processes all operations as ‘pure’ functions (taking some values and translating them into other values).

MSTO Framework refers to all of the runtime mechanisms and compilers, including the APIs for the runtime and compilers, and the Kernel classes.

MSTO System is the term that is used to refer to the larger system (e.g., CAL, MSTOs, MSTO models, Gem Cutter, and repository) in addition to the “MSTO Framework”.

Business Intelligence (BI) is a term used to describe a category of systems and applications used to gather, store, provide access to, and analyze data to help enterprise users make better business decisions. Applications that exemplify business intelligence include query and reporting, online analytical processing (OLAP), profiling, statistical analysis, and forecasting.

Business Intelligence Logic (or Data Modeling) Level is used to describe the application level that provides the logical framework that describes data flow and the transformation of data. The transformation of the data is based on specific defined and extensible Business Intelligence logic that structures the data flow. This term is used to differentiate from the Business Intelligence Architecture Level.

Business Intelligence Architecture Level is used to describe the application level that provides the physical framework that describes the interactions between servers and their services (e.g., a service based ‘bus’ architecture). This level provides a ‘physical’ framework, where servers and their services can be discovered and managed effectively within a more organic, reliable and scalable system. While this type of solution deals efficiently with the unit of execution of different major faculties in a BI infrastructure, it does not deal with the logic of BI itself.

A Data flow is used to describe the transformation of data from one state into another state. A data flow is defined by one or more MSTOs (in combination). A data flow persists in a workspace in memory while it is needed and is not necessarily permanently stored. When a data flow is run, a MSTO is created to represent the data flow.

A Data Entity is a data type and constructors for that type. Constructors are the only way to create a data type.

A Data Constructor is an optionally parameterized symbol that introduces a value of a certain type.

A Data Model is the combination of Data Entities and MSTOs that transform the data.

A Workspace is where loaded modules exist and where new data flows, MSTO entities, and data entities can be created. A workspace exists within memory.

A Perspective is a view into a workspace defining a working module and the visibility of all functions and data from other modules according to their own scoping direction.

A Container Application is an application that implements one or more data flows that are constructed using MSTOs. Most often a container application is programmed in an imperative programming language for use in managed code platforms (such as Java and .NET).

A Repository is where MSTOs are stored. Inside a Repository are Modules. Repositories are ultimately some form of physical storage mechanism (like a file or database). A Repository is represented by the UI metaphor of a “Vault”.

A Module is a synonym for a “drawer”. When a workspace is initiated the modules that will be available for use within the workspace are set up based on a perspective for the workspace. In use, modules exist within a workspace. Modules provide an organizing principle that categorizes MSTOs based on overall function. For instance, there is a module for the very basic MSTOs and data entities and other modules for list manipulating MSTOs, arrays, data access MSTOs, etc. Repositories and modules may have visibility and accessibility restricted, so that only certain people, groups or roles have access to them.

A Vault is a synonym and UI metaphor for a “repository”.

A Drawer is a synonym and UI metaphor for a “module”.

The Gem Cutter is a design tool for MSTOs, providing tools needed to build, combine and test MSTOs. The design emphasis is an environment where the developer can develop business logic more organically than using traditional approaches. The Gem Cutter only allows the creation of ‘legal’ MSTOs that have meaningful relationships to the data and to each other. The environment promotes a Rapid Application Development approach to business. The Gem Cutter was initially disclosed in US23071844A1, which is incorporated herein by reference.

An Application Model specifies the combination customization and session MSTOs that are combined to create the model for an application to use. An application model is often stored separately as a file.

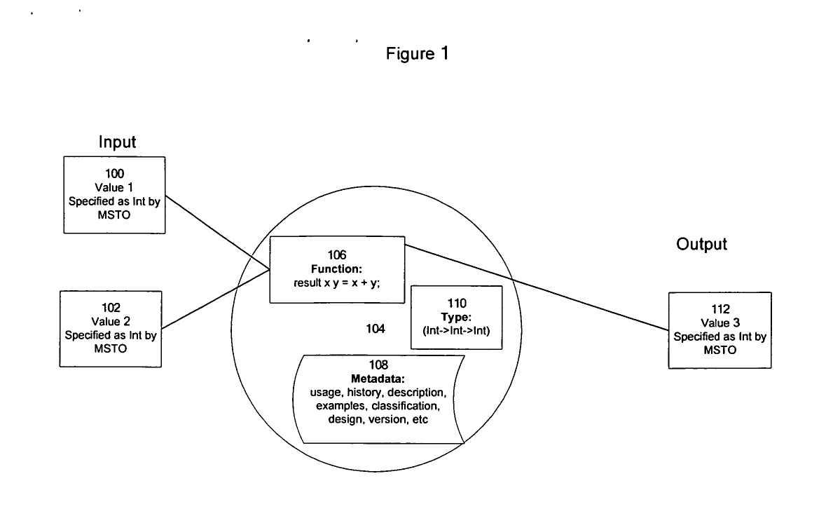

FIG. 1 illustrates an MSTO 104 that adds a first value 100 and a second value 102 to produce a third value 112. The MSTO 104 comprises a function 106, metadata 108, and type information 110. In this example, the MSTO function 106 is identified as “result x y=x+y”, meaning that the MSTO produces a result from two values x and y, and the result that it produces for these values (x and y) is equal to the sum of x added to y. The type information 110 is specified as Int>Int>Int, indicating that both x and y and the output result are of the type Int (integer). The metadata 108 contained in the MSTO provides such information as the MSTOs name, version, category, and any specific interaction constraints that may be specified for the MSTO. A user can specify a MSTO using code or a visual IDE. A MSTO can also be defined using CAL or an imperative programming language designed to be hosted by managed code platforms, such as Java or .NET.

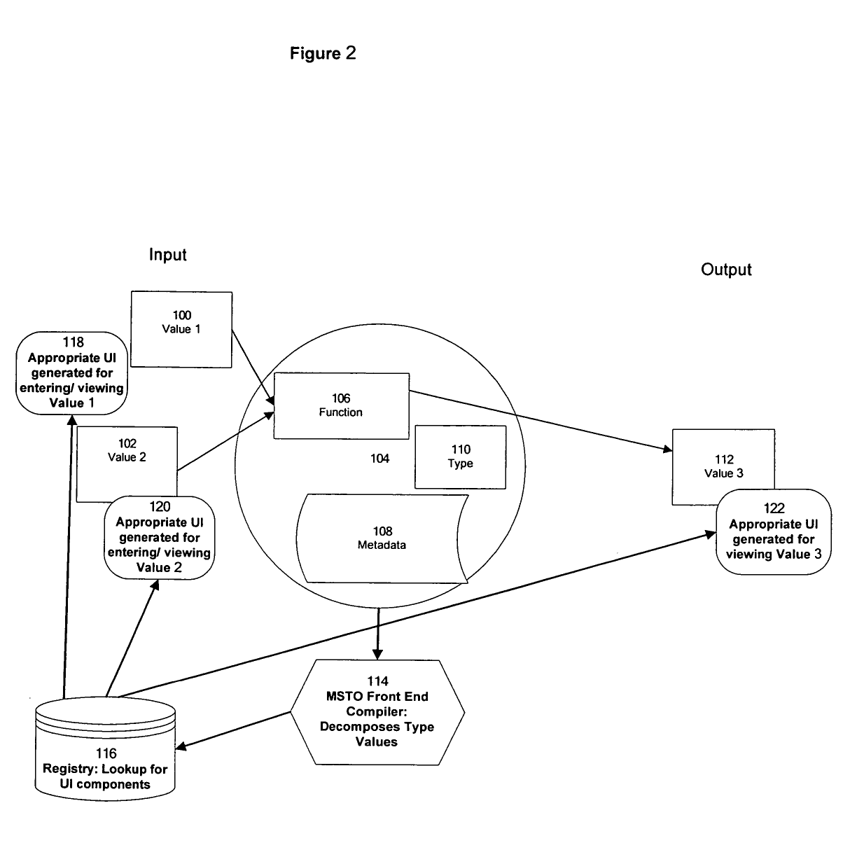

FIG. 2 generally corresponds to FIG. 1, but additionally illustrates the user interfaces (UIs) for entering and viewing values associated with the MSTO. User interfaces 118 and 120 are used to enter values 100 and 102, respectively, while user interface 122 displays output 112. Each UI may be fetched from a registry 116. In one embodiment, the 8. MSTO front end compiler 114 decomposes type values and provides UI components based on a registry lookup 116.

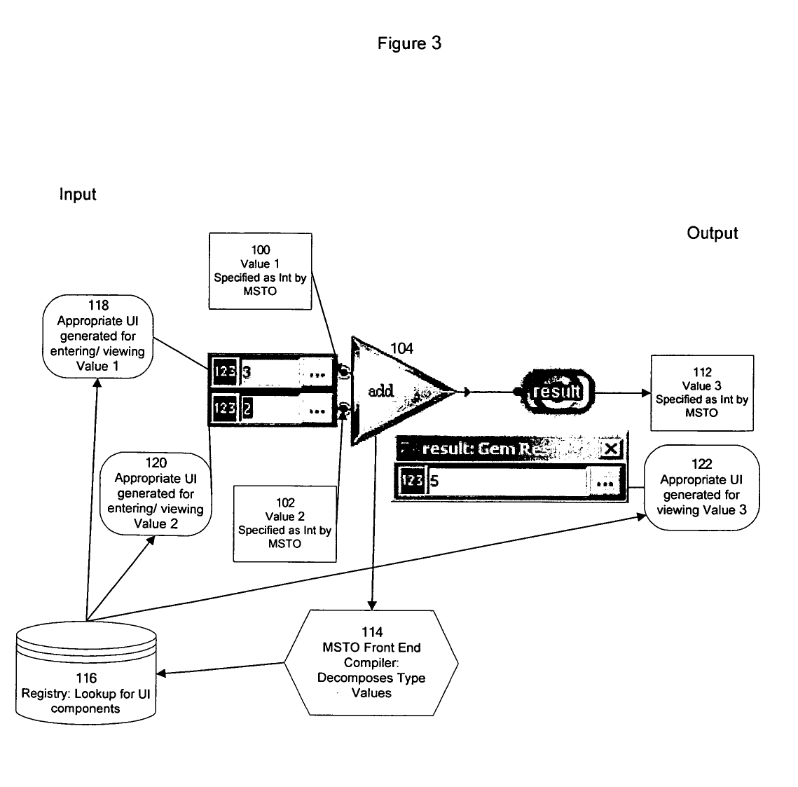

FIG. 3 generally corresponds to FIG. 2, but illustrates exemplary UI components and associated values. UIs 118 and 120 enable the user to enter and view input values, while UI 122 allows the user to view the result 122. The MSTO 104 performs an add function. This component is a standard MSTO library component that is available when constructing data flows and models.

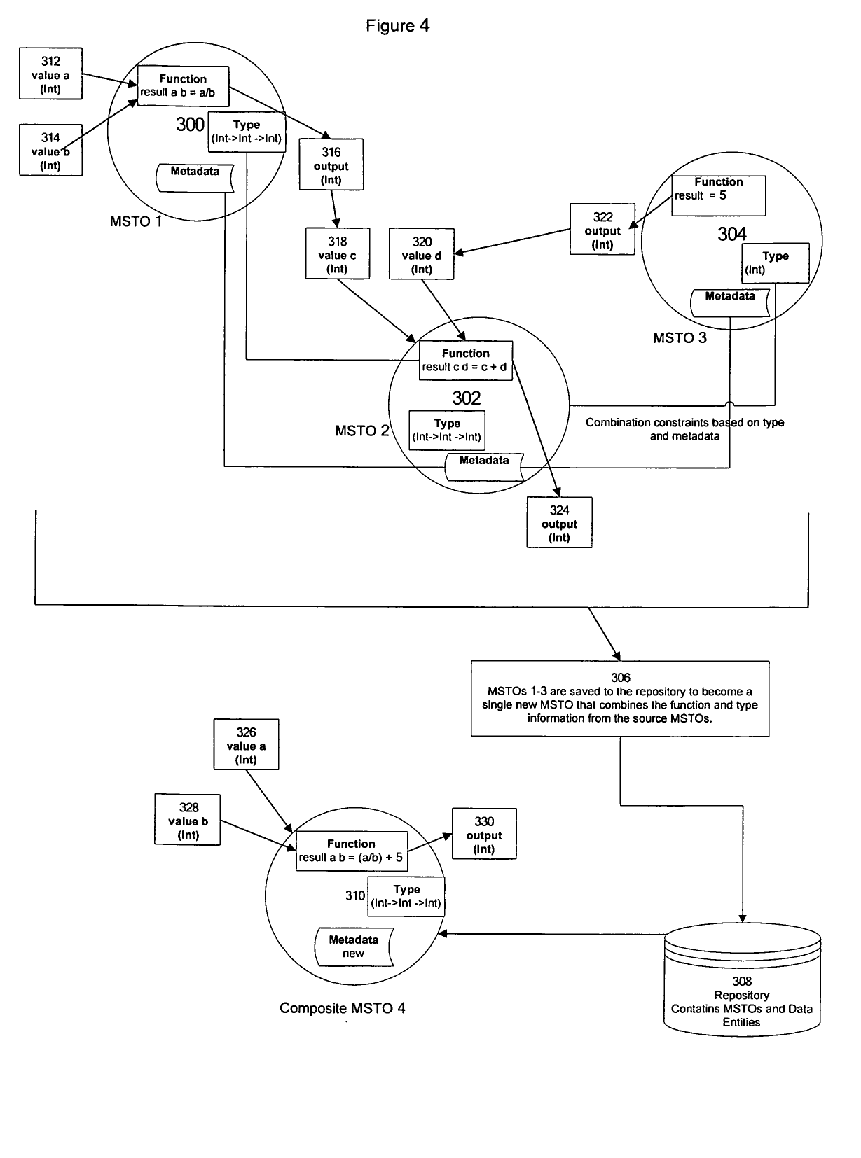

FIG. 4 illustrates the combination of three MSTOs 300, 302, 304 that form a simple data flow. The combined MSTOs can be saved 306 to the repository 308 to create a composite MSTO 310. The composite MSTO 310 contains a combination of the function, type, and metadata information from the original MSTOs (300, 302, 304).

There are constraints on how MSTOs 300, 302, and 304 can be combined based on type information and restrictions identified in metadata. In this example, the MSTOs all have the same input and output types (Int). Also, there is no Metadata based category or usage restraint in this example that would constrain the MSTOs and prevent connections.

MSTOs may be configured to transform type values. This allows incompatible MSTOs to be combined to create data flows. For example, consider a case where it is desirable to connect MSTO x to MSTO y, but MSTO x produces an output that is incompatible with the type that MSTO y processes. In this case, another MSTO z positioned between MSTO x and MSTO y is used to transform the value output from MSTO x to the value MSTO y takes as input. For example, in an embodiment of the invention there is a standard MSTO “convertToInt” that takes a double precision (e.g., floating point) value and converts it to an integer value.

FIG. 4 illustrates the combination of the following MSTOs:

300—MSTO 1

Function: result a b=a/b; Type: (Int->Int->Int)

302—MSTO 2

Function: result c d=c+d; Type: (Int->Int->Int)

304—MSTO 3

Function: result=5; Type: (Int)

This combination results in a composite MSTO:

310—MSTO 4

Function: result a b=(a/b)+5; Type: (Int->Int->Int)

MSTO 310 combines the functions and typing information found in MSTOs 300, 302, 304 to consolidate this information. Given how the MSTOs were combined, as discussed below, much of the functionality/type requirements from MSTO 2 are no longer broken out in the function or type information.

MSTOs 300, 302 and 304 are combined to create MSTO 310 in the following manner.

Since every MSTO takes or outputs only integers, their types are compatible and they can be easily combined. In particular:
1. MSTO 1 300 requires two unspecified (or user specified) input values (a & b). These values are indicated as 312 and 314. The function in MSTO 1 operates on values 312 and 314 to produce output 316.
2. MSTO 1 300 passes its output 316 to MSTO 2 (302) to provide the value for MSTO 2's input 318. MSTO 2 302 requires two values (c & d or 318 & 320) for its function.
3. MSTO 3 304 passes its output (the fixed value 5) to MSTO 2 to supply the value for MSTO 2's input 320.
4. At this point, MSTO 2 302 has the two input values (318, 320) to create its output 324.
   This unsaved data flow can be persisted in a workspace, or optionally MSTOs 1-3 can be saved 306 to the repository 308.

MSTO 4 310 is a single MSTO that combines the function and type information from the original 300, 302 and 304 MSTOs. MSTO 4 combines and applies the function, type and metadata information from the original MSTOs 300, 302 and 304.

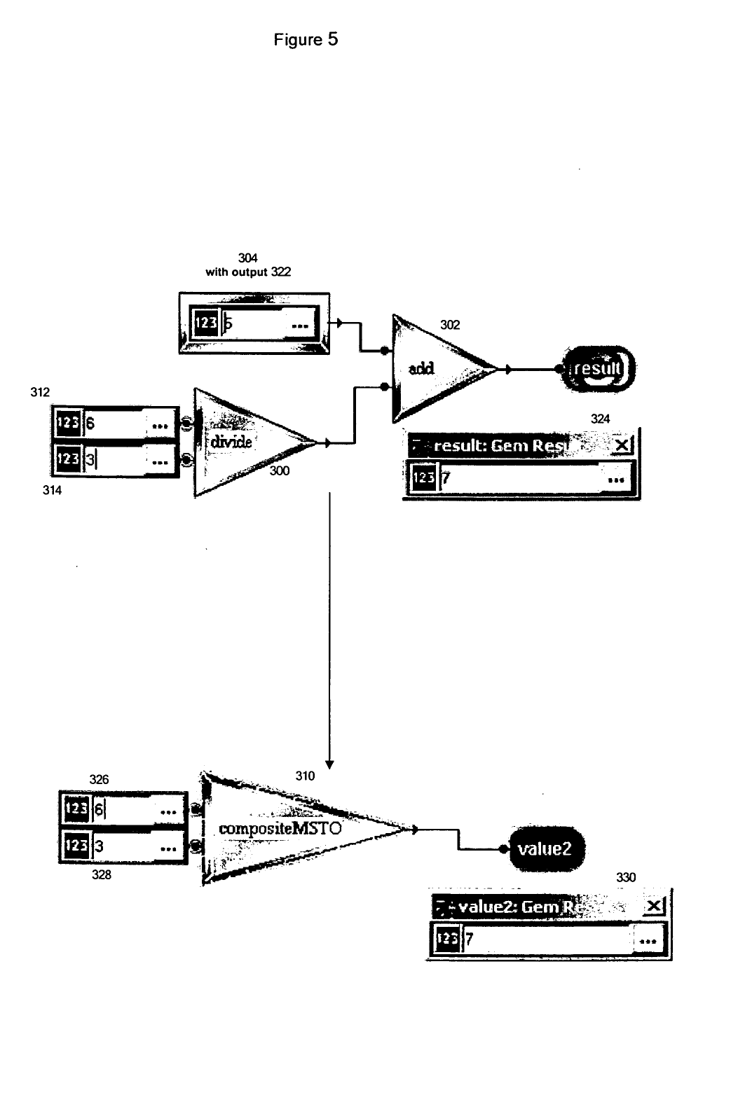

FIG. 5 illustrates graphical components corresponding to the functional components shown in FIG. 4. In FIG. 5, MSTO 300 is a divide block, which receives an input value of 6 from graphical component 312 and an input value of 3 from graphical component 314. MSTO 302 is an add block, which receives the output of the divide block 300 and an input value from the MSTO block 304, which provides a constant value of 5. An output graphical component 324 displays the result of 7.

Optionally, the data flow that combines MSTOs 300, 302 and 304 can be saved to the repository as a single MSTO (compositeMSTO) 310 that has the input requirements from the original divide MSTO 300, but internally performs the rest of the function on these inputs to produce a result 330. Composite MSTO 310 has functionality that matches the functionality of the combination of 300, 302, and 304. Therefore, the result 330 from composite MSTO 310 is equivalent to the result 324 when the same input values are provided.

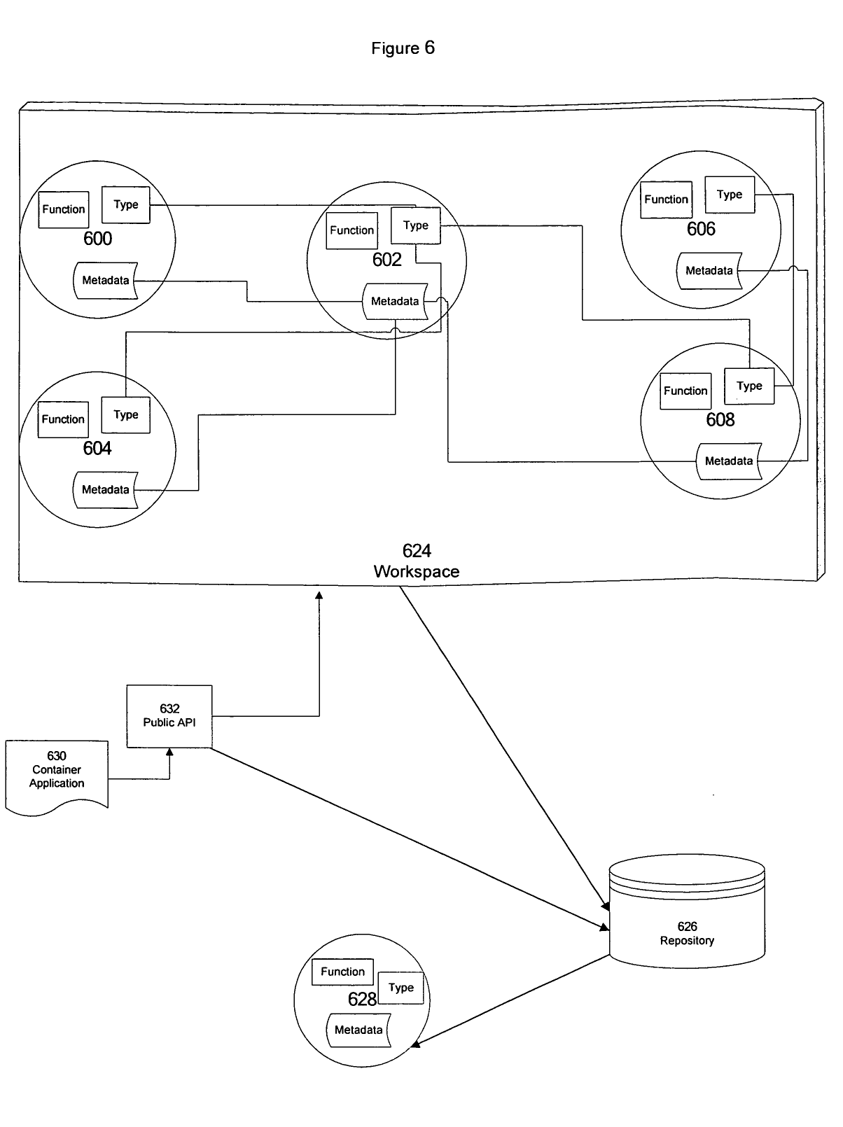

FIG. 6 shows a data flow constructed within a workspace, which is stored in memory. The figure also illustrates how the data flow can be stored in the repository as a single MSTO. The diagram also indicates at a high level how container applications access data flows and MSTOs.

MSTOs 600-608 are combined to create an exemplary data flow. There may be any number of MSTOs. These MSTOs may be the composite of many other MSTOs that were previously combined and stored in the repository as single MSTOs.

The data flow is created and stored in a workspace 624, which is stored in memory. From its location in memory, the data flow can be persisted and accessed by Container Applications 630 via a public API 632. In this way, the container application can access the logic and processing found within the data flow.

The data flow can be saved to the repository 626. Once it is stored in the repository, it will become a composite MSTO 628 that contains all of the logic from the original data flow in a single MSTO.

The data flow can exist both as a saved MSTO and as a data flow within the workspace at the same time. It can be advantageous to have both a permanently stored version (the MSTO) and a workspace version (the data flow) so that one can save one version, but continue to modify the data flow within the workspace to create new potential MSTOs by changing the composition of the data flow.

The MSTO 628 represents the combination of MSTOs in the original data flow in one single composite MSTO. The container application 630 is able to use the main public API 632 to access either a data flow stored in a workspace 624 or an MSTO stored in the repository 626. In both cases the container application can use API functionality, such as looking up types, running MSTOs or modifying MSTOs. The public API 632 is used by container applications 630 to access MSTO functionality either through the workspace 624 and data flows or through the repository 626 and stored MSTOs.

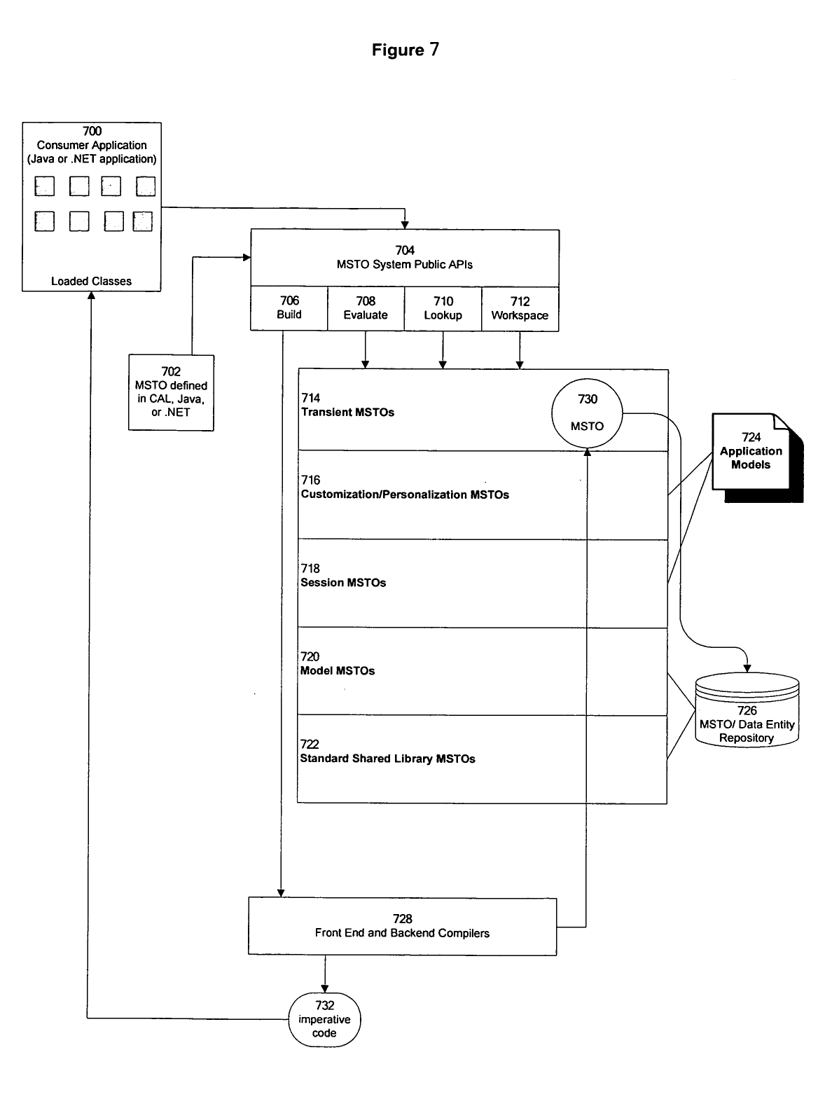

FIG. 7 illustrates an overview of the architecture of the system including how the workspace fits in with other components and how within a workspace MSTOs exist at different levels of permanence. The consumer application 700 accesses the MSTO system Public APIs 704. Additionally, a MSTO defined using CAL, Java, or .NET 702 can also access the MSTO system Public APIs 704.

These APIs provide access to Build 706, Evaluate 708, Lookup 710, and Workspace 712 functionality. Build provides compiler 728 functionality.

The workspace 712 exists in memory, which is the area where MSTOs are manipulated. The MSTOs can be understood as existing on a number of levels. These levels are intended to be illustrative, rather than limiting. Transient MSTOs 714 snap together to provide a data flow to represent a specific workflow. Transient MSTOs 714 are created programmatically on the fly and are not saved.

Customization/Personalization MSTOs 716 are adjuncts to the model level MSTOs, providing additional behavior relevant to the application/user/or deployment. Session MSTOs 718 are MSTOs that are loaded to form a session environment. Customization/Personalization MSTOs 716 and Session MSTOs 718 constitute a user session.

Model MSTOs 720 represent key entities and transformations for a particular BI use or application. The model MSTOs 720 provide a high level “language” that defines a model. Standard shared library MSTOs 722 are core MSTOs that provide standard functionality for re-use across multiple applications. Model MSTOs 720 and Standard Shared Library MSTOs 722 are persistent and are stored within the repository 726.

A MSTO connects to other MSTOs at levels that reflect a greater degree of permanence. A transient 714 MSTO would typically create a data flow that connects with MSTOs through levels 716, 718, 720, and 722.

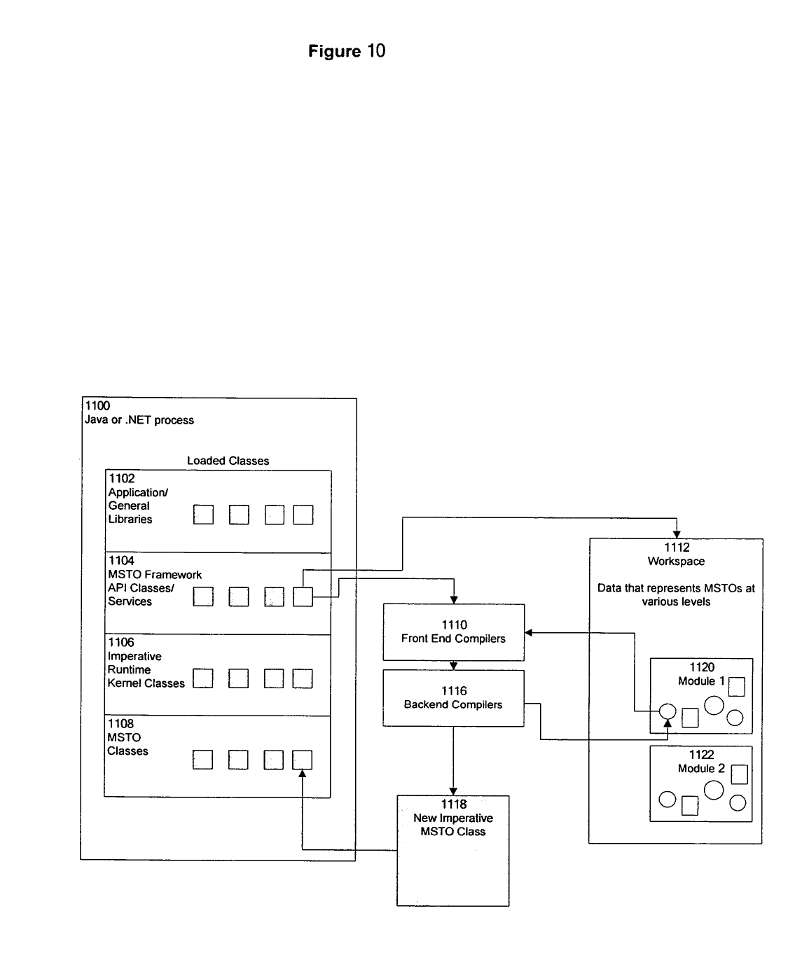

Front end and backend compilers 728 can compile MSTOs within the workspace 712. The compilation results in the production of another transient MSTO 730 and can optionally produce imperative code 732. The transient MSTO 730 can be saved to the repository 726 as a permanent composite MSTO. Application models 724 are “recipes” for constructing data flows that are scripted in an application specific way. Application models 724 are used to automate the creation of MSTOs via the Build API 706. This functionality as it relates to the classes loaded in a Java or .NET process is discussed in connection with FIG. 10.

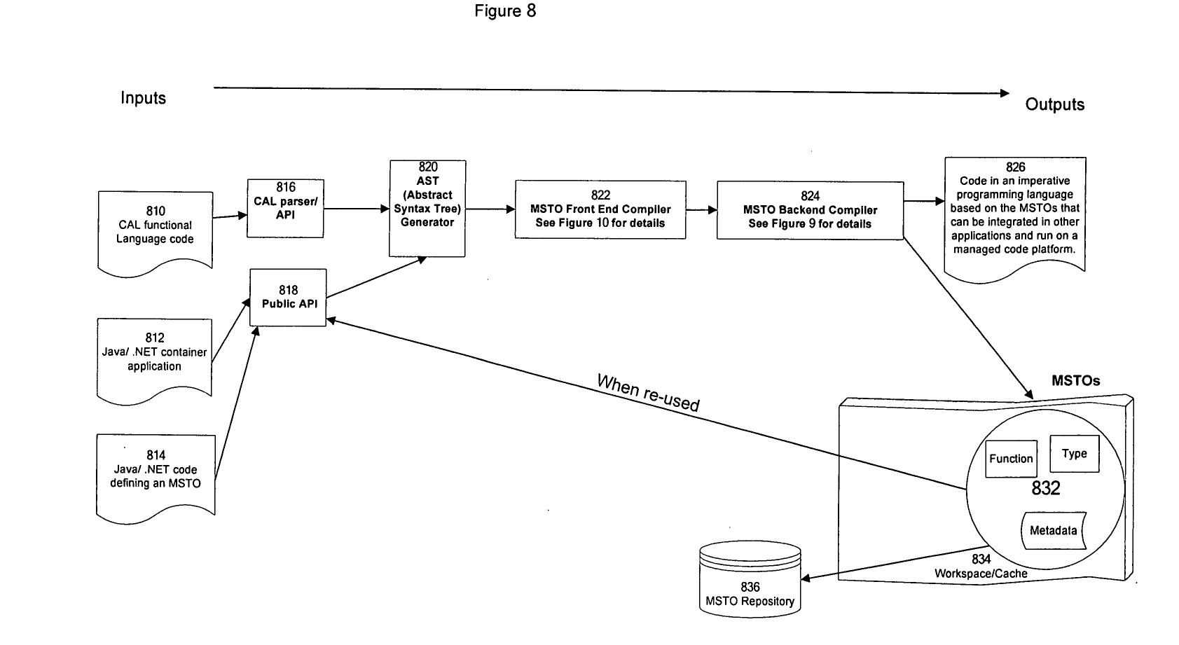

FIG. 8 illustrates components used to compile and store MSTOs. There are four potential forms of input for the process. CAL functional language 810, goes to a CAL specific parser API 816. Java/.Net container applications 812, Java/.Net code defining a MSTO 814, or an MSTO 832 (from either the workspace 834 or repository 836) can access the public API 818. Java and .NET are used as examples of imperative programming languages run on a managed code platform.

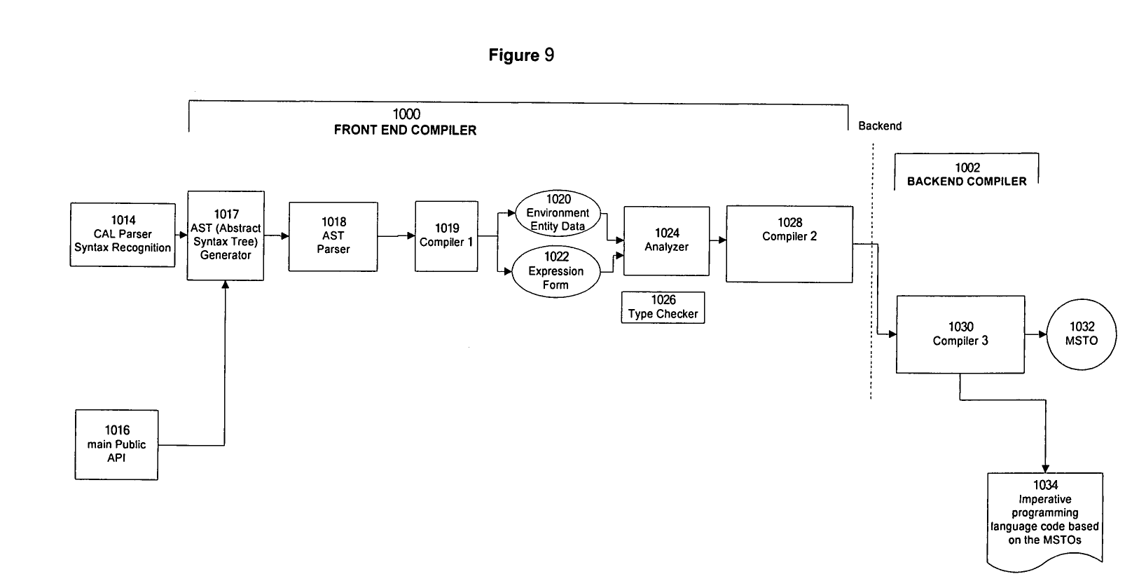

Both the CAL parser/API 816 and the main public API 818 access an AST (Abstract Syntax Tree) Generator 820. Processing then proceeds to MSTO front-end compiler 822, which provides entity and expression analysis and creates a MSTO definition that is passed to the Backend Compiler 824, which is discussed in connection with FIG. 9.

The compilation process produces MSTOs 832 that exist within a workspace 834 and can be saved to a repository 836. The MSTO 832 can be re-used by accessing the public API 818. The compilation process can also produce code 826 in an imperative programming language. This code can be reloaded into the originating process as a loaded class that will be available to the container application 812 the next time that the class is called.

FIG. 9 provides additional information on the front-end compilation process. Potential inputs for this process include: native MSTOs, MSTOs defined using CAL, Java, or .NET. The CAL parser 1014 is only used by code that is written in CAL. Native MSTO objects or code written in imperative programming languages use the main public API 1016. An Abstract Syntax Tree (AST) is then generated 1017. Compilation uses an AST as the compiler's internal data structure representation of the original computer program that is being optimized.

The AST is passed to the AST parser 1018. The AST parser 1018 performs source level transformation and hierarchical optimization before passing the AST to Compiler 1019. Compiler1 1019 separates the symbols and definitions of symbols within the AST. The Environment Entity Data 1020 identifies the symbols and the scope of the symbols and functions. The Expression Form 1022 defines the symbols with a high-level syntax form. The Analyzer 1024 works with the separated Entity Data and Expression Form to perform global manipulation and processing at the symbolic level. The Type Checker 1026 is part of the global analysis. Type checking is particularly important for the overall MSTO process. It is this type checker 1026 that is used to confirm which MSTOs have compatible type information and can be snapped together. Compiler 2 manipulates the expression form and the environment entity data to prepare a MSTO definition for backend compilation. Compiler 2 performs expression optimizations. The Backend compilation is done using Compiler 3 1030, a custom code generator, that produces Java/.NET byte code 1034 as well as MSTOs 1032.

The MSTO 1032 and code 1034 that are output are very much interconnected. The code 1034 is the representation of the MSTO that enables it to exist within the scope of a container application in Java or .NET.

FIG. 10 illustrates classes within Java or .NET processes and how they connect to the workspace and compilation. Within the container .NET or Java application process 1100, there are four types of classes of interest. There are application and general libraries 1102 that define the application and its general functionality. There are MSTO Framework API and service classes 1104 that provide access to the functionality of the API. There are Imperative Runtime Kernel classes 1106 that are used at runtime to apply the reduction order and provide basic types. There are also classes that represent executable MSTOs 1108 within the process.

Using the API 1104, the process to build and compile MSTOs can be launched and the Workspace 1112 that contains the MSTOs and data entities is accessed. Within the workspace 1112 is the data that represents the MSTO entities and data entities. Two modules 1120 and 1122 containing various MSTO entities and data entities are shown within the workspace. The workspace can contain any number of modules.

The Java process 1100 can initiate a change to the workspace by adding/deleting/loading and overwriting MSTOs and modules. When a change is initiated that affects one of the MSTO classes that the process has loaded 1108, the Java process 1100 uses the API classes 1104 and accesses the workspace 1112 that contains the data for those MSTOs. Using the workspace MSTO entities, the MSTOs are modified (as defined in the Java process) and then the MSTOs in the workspace are passed into the compilation process 1110-1116. During the compilation process, the MSTO entity in the workspace 1112 is updated. At the end of the compilation process, the new imperative class 1118 is reloaded into the process 1100.

As previously discussed, a group of connected MSTOs in a workspace is referred to as a dataflow. Data flows can provide complex functionality defined by the combination of a number of MSTOs. Although the examples provided have focused on simple combinations of MSTOs, it should be noted that MSTOs can be nested to any depth. Therefore, composite MSTOs can contain the definition of hundreds of MSTOs that were previously combined to perform intermediate data transformations.

A group of connected data entities and MSTO entities form a data model. These data models describe the logical framework for specifying the data flow and the transformation of specific data. For example, a data model could be defined to take the entire contents of one database, transform and clean the data, and then output the data with a new schema. This would require a number of MSTOs to be combined in complex ways in order for the data transformations to work. The component shapes of the data model (such as its initial schema and its target schema) would be described by data entities within the model.

In accordance with one embodiment of the invention, MSTOs are compiled for use in an imperative programming language hosting managed code platforms. MSTOs as semantic objects need a model for evaluation, while MSTOs can be interpreted, their application to BI (and large scale data processing) requires an efficient evaluation approach. Therefore, MSTOs are designed for conversion to byte codes and are directly executed on managed code platforms (such as Java and .NET).

For practical and performance reasons, a key aspect of MSTOs is that they integrate tightly into BI applications written using standard programming languages. This integration implies the successful fusion of modular lazy functional evaluation within an imperative framework.

As shown in FIGS. 9-10, the invention includes a system of compilation to enable the MSTOs to be compiled to programming languages where the programming languages themselves do not support lazy functional evaluation, but the generated code has strengths associated with the lazy functional evaluation paradigm.

APIs support the integration of MSTOs within applications written in other programming languages. In one embodiment, there are two public APIs for defining MSTOs. The first API defines MSTOs through syntax and the second defines MSTOs by relating existing MSTOs in a graph. The second API is the one that will primarily be discussed for its exemplary functionality. This API describes MSTOs in terms of existing MSTOs and is very close to the graphical language in the Gem Cutter in terms of how it handles the validation and composition of MSTOs.

In one embodiment, there are four broad categories of API functionality: build, evaluate, lookup, and workspace. Build aspects of the API are connected to compiler functionality and type checking. Evaluate functionality takes a data flow and runs it with specified arguments until Weak Head Normal Form is reached, which is the point at which minimal work has been done to begin producing results. A consumer may then begin requesting elements of the result at which point a quantum of evaluation is performed in order to return just one element.

Lookup permits the dynamic discovery of MSTOs at runtime, which is critical to working with and combining MSTOs on the fly. Lookup for MSTOs can occur based on name, module or type contract (types of input and/or types of output).

The workspace API manages the workspace loading and saving modules, loading different workspaces, writing out workspaces, adding or deleting modules within the workspace, and recompiling the workspace in full or part.

An embodiment of the invention uses a registry lookup for UI components.

A registry-based lookup for UI components provides the appropriate UI component for a value based on the type of the value. These UI components are used within Crystal Gem Cutter and can be used within other applications that decompose MSTOs.

An embodiment of the invention also uses a Crystal Gem Cutter. Crystal Gem Cutter is the Visual IDE that supports the development and use of MSTOs. U.S. patent publication US23071844A1, which is incorporated herein by reference, discloses the key aspects of the Visual IDE.

The repository systems that support the loading and saving of MSTOs by other applications are also disclosed in US23071844A1. Not all MSTOs are stored within repository systems since MSTOs are often constructed in transient data flows to support a specific activity and are not persisted when that specific activity ceases. When MSTOs are saved to the repository, the data flow is compressed to become a single composite MSTO. In addition to MSTOs, data entities are also stored within the repository.

CAL is the proprietary functional programming language developed to support the development and use of MSTOs. US23071844A1 discloses key aspects of CAL.

Attention now turns to a description of MSTO integration within another application.

The following example demonstrates how MSTO based data modeling can be applied in an application; the example is for the purpose of illustration, and therefore the invention should not be interpreted as being limited to the example.

A container application is written using an imperative programming language, such as .NET or Java. The imperative programming language provides the UI and handles the “physical framework”, such as working with the operating system, attached devices, network connections, printing etc.

General processing operations for container applications working with MSTOs include:
1. The container application connects to the MSTO repository and initializes a workspace.
2. The container application loads MSTO references. This can be by name or by discovery of which MSTOs within the repository have a particular characteristic (such as the ability to make a specific transform).
3. The container application can join MSTOs to construct more complex calculations or evaluate MSTOS with specific data or arguments.
4. The container application can save new MSTOs to the repository for future use.

The invention may be used in connection with an application that deterministically constructs a text question for application to a data source. Such an application is disclosed in the concurrently filed and commonly owned U.S. patent application entitled, “Apparatus and Method for Deterministically Constructing a Text Question for Application to a Data Source”, Ser. No. ______, filed Apr. 7, 2005, the contents of which are incorporated herein by reference.

In this application, a user is supplied with an initial text question (e.g., in a GUI). The user is allowed to alter a sentence component of the text question (e.g., using GUI pull-down menus) to form an altered sentence component. When the altered sentence component in combination with remaining sentence components creates an invalid question, sentence components are supplied to insure the selection of a valid question. A data source query (e.g., SQL) is constructed from the initial text question and at least one altered sentence component. The data source query is applied to a data source (e.g., a database) to produce data results. The data results are then presented to the user.

In this application, the container application is called Question Panel. The question panel application is a simple Java application that creates a window consisting of a menu, toolbar and a HTML viewer. The application loads question MSTOs from the repository and these define both the original form of a question, and how the pieces of a question can be edited. MSTOs can also transform a question into English language, results, SQL etc. One such MSTO can translate the existing question directly into HTML, complete with hypertext for the pieces. This MSTO is used to create the content of the panel that is then rendered in the window. Hypertext events (when the user clicks on the pieces) are handled by the question panel application and these modify the current question. This is the question edit-cycle.

MSTO based data modeling content includes data flows and models constructed using the MSTOs that can be used to provide advanced functionality to the container application.

In this example, some of the key types of MSTOs used by the question panel application include: question constructor MSTOs, subject MSTOs, verb MSTOs, time range MSTOs and question reformatting MSTOs.

First, the question panel application connects to the MSTO repository and initializes a workspace. Before an application can begin using MSTOs, it connects to an MSTO repository and initializes a workspace. A workspace is a collection of MSTO modules that the application wants to use. A gemServices API is initialized with a given workspace with modules from a particular repository, and with a particular perspective. A perspective defines which module the Gem services are logged to (for creating new MSTOs and determining which MSTOs are visible in other modules).

Below is an example of the service initialization code in the QuestionPanelApp constructor:

// Initialize CAL gem services.
gemServices = new QuestionPanelGemServices (TARGET_MODULE,
WORKSPACE_FILE);

QuestionPanelGemServices is a simple subclass of GemServices provided by the basic Gem API. The next argument indicates the workspace file that contains information about how the workspace is configured (including which Modules to load).

The question panel application loads MSTO references. This can be by name or by discovery of which MSTOs within the repository have a particular characteristic (such as the ability to make a specific transform). The next section of initialization code loads MSTO (Gem) references for different types of MSTOs that the application will find “interesting” and wants to manipulate:

// Get the full list of verb gems.
allVerbGems = getAvailableVerbInfoGems( );
// Get the full list of dimension scope gems.
allDimensionScopeGems = getAvailableDimensionScopeGems( );
// Get the list of available time frames.
allTimeFrames = getAvailableTimeFrameGems( );
// Get the list of available time ranges.
allTimeRanges = getAvailableTimeRangeGems( );
// Get the list of available query style gems.
allQueryStyles = getAvailableQueryStyleGems( );
// Get the list of available items; send to gems.
allSendToGems = getAvailableSendToGems( );

The above code loads MSTOs (Gems) matching a particular pattern into list instance fields in the question panel application. Finally, to complete initialization, the first ‘document’ (complete question) is created using the initial (default) values for each question section:

// Construct the initial document.
makeNewDocument( );

This concludes the initialization of the Question Panel application. Below is sample code that demonstrates the routines that look up the lists of Gems. The method ‘getAvailableTimeFrameGems’ is the simplest of these, fetching the Gems that it needs by name. The service method ‘getGemEntity’ returns a GemEntity, which is the representation of a Gem (MSTO) in Java.

```
/**
  * Returns the full list of the available time frame gems.
  * @return a list of items describing the available time frame gems
  */
  private List /*TimeFrameGemInfo*/ getAvailableTimeFrameGems( ) {
    List timeFrameGems = new ArrayList( );
    GemEntity areGem =
    gemServices.getGemEntity(“QuestionBasedQuery.Are”);
    GemEntity wereGem =
    gemServices.getGemEntity(“QuestionBasedQuery.WereAsOf”);
    GemEntity willBeGem =
    gemServices.getGemEntity(“QuestionBasedQuery.WillBe”);
    timeFrameGems.add(new TimeFrameGemInfo(“are”,
    areGem, false));
    timeFrameGems.add(new TimeFrameGemInfo(“are not”,
    areGem, true));
return timeFrameGems;
  }
```

A slightly more complex example (but more in keeping with the dynamic nature of Gems) is when the code ‘discovers’ MSTOs (Gems) that are capable of making a particular transform. In this case, code performs a search for the MSTOs that match the required criteria. In the code below, a TypeExpr is obtained to describe the type of Gems required and a GemFilter instance is created with a selector function that is used as a delegate in the getMatchingGems method. This returns a set of Gems. The rest of the code reads interesting Gem metadata from each returned Gem.

```
/**
  * Returns the full list of the available query style gems.
  * @return a list of items describing the available query style gems
  */
  private List /*QueryStyleGemInfo*/ getAvailableQueryStyleGems( ) {
    // Create a filter which will find all gems which return the
    QueryStyle type.
    final TypeExpr queryStyleTypeExpr =
gemServices.getTypeFromString(“QuestionBasedQuery.QueryStyle”);
    if (queryStyleTypeExpr == null) {
      return Collections.EMPTY_LIST;
  }
  GemFilter filter = new GemFilter( ) {
    public boolean select(GemEntity gemEntity) {
      TypeExpr gemResultType =
      gemEntity.getTypeExpr( ).getResultType( );
      return TypeExpr.canPattenMatch(gemResultType,
      queryStyleTypeExpr,
gemServices.getTargetModuleTypeInfo( ));
    }
  };
  Set gemSet = gemServices.getMatchingGems(filter, false);
  // Construct a QueryStyleGemInfo object for each gem.
  MetadataManager metadataManager = MetadataManager.getInstance( );
  List queryStyleInfoList = new ArrayList( );
  for (Iterator gemIter = gemSet.iterator( ); gemIter.hasNext( );) {
    GemEntity gemEntity = (GemEntity) gemIter.next( );
    FunctionalAgentMetadata functionMetadata =
    (FunctionalAgentMetadata)
metadataManager.getMetadata(gemEntity.getEnvEntity( ));
    String displayText = functionMetadata.getDisplayName( );
    if (displayText == null || displayText.length( ) == 0) {
      displayText = gemEntity.getName( ).getUnqualifiedName( );
    }
    queryStyleInfoList.add(new QueryStyleGemInfo(displayText,
    gemEntity));
  }
  return queryStyleInfoList;
}
```

Once the application has accessed some MSTOs, there are two common activities: join the MSTOs together to express a more complex calculation or evaluate the MSTOs with some specific data or arguments.

Below is the code that takes the state of the question panel UI and connects the MSTOs (Gems) appropriately based on this template to arrive at a question gem that can be evaluated.

The method getQuestionPartGem retrieves the Gem for a part of the question given what is in use in the currently constructed question. Once the various question part Gems have been collected, the last part of the method simply ‘snaps’ them into the questionGem being constructed. Notice how each ‘input part’ of the questionGem is obtained and is connected to the part of the question.

```
/**
  * Builds a question gem for the current state of the UI.
  * @return a gem object for the current question
  */
  private Gem makeQuestionGem() {
    Gem scopeGem =
    document.getQuestionPartGem(DIMENSION_SCOPE);
    Gem verbGem = document.getQuestionPartGem(VERB);
    Gem timeRangeGem =
    document.getQuestionPartGem(TIME_RANGE);
    // The value of the TIME_FRAME part has info about both the
time frame and the ‘not’ option.
    TimeFrameGemInfo timeFrameInfo = (TimeFrameGemInfo)
document.getQuestionPart(TIME_FRAME);
    Gem timeFrameGem =
    new FunctionalAgentGem(timeFrameInfo.timeFrameGem);
    Gem notGem = new ValueGem(new
LiteralValueNode(Boolean.valueOf(timeFrameInfo.notQuestion),
TypeExpr.BOOLEAN_TYPE));
    FunctionalAgentGem queryStyleGem = (FunctionalAgentGem)
document.getQuestionPartGem(QUERY_STYLE);
    // Hook up any inputs on the queryStyleGem.
    connectQueryStyleInputs(queryStyleGem);
    Gem questionGem =
gemServices.getFunctionalAgentGem(“QuestionBasedQuery.Question”);
    QuestionPanelGemServices.unsafeConnectGems(scopeGem,
questionGem.getInputPart(0));
    QuestionPanelGemServices.unsafeConnectGems(timeFrameGem,
questionGem.getInputPart(1));
    QuestionPanelGemServices.unsafeConnectGems(notGem,
questionGem.getInputPart(2));
    QuestionPanelGemServices.unsafeConnectGems(queryStyleGem,
questionGem.getInputPart(3));
    QuestionPanelGemServices.unsafeConnectGems(verbGem,
questionGem.getInputPart(4));
    QuestionPanelGemServices.unsafeConnectGems(timeRangeGem,
questionGem.getInputPart(5));
    return questionGem;
  }
```

The following code demonstrates how the questionGem is evaluated. The question itself is just a MSTO. It represents all of the semantics of a particular question, but it only evaluates to itself (the question). To do interesting things with a question, it is snapped into a MSTO that transforms the question into something that is desired (data, SQL, an email, etc). The QuestionBasedQuery Gem module includes a number of MSTOs to do this, but in this particular example, returned SQL is illustrated.

In this example, the application uses the MSTO to convert a question to a SQL string by name using answerQuestonAsSQL. A reference to this Gem from the workspace is obtained using ‘getFunctionalAgentGem’ and call it ‘questionSqlGem’. This Gem has one input (the question to be converted to SQL). Then the application connects the question (questionGem), which is returned by the routine, to the first (0) argument of questionSqlGem. The application defines a String to hold the SQL to be produced. Then the application uses gemServices to run the ‘questionSqlGem’ which returns a string.

```
/**
  * Returns the SQL needed to answer the current question.
  * @return the SQL needed to answer the current question
  */
  private String getSqlForQuestion() {
    // Construct a gem which will get the SQL needed to answer
    the current question.
    Gem questionSqlGem =
gemServices.getFunctionalAgentGem(“Ques-
tionBasedQuery.answerQuestionAsSQL”);
    Gem questionGem = makeQuestionGem();
    QuestionPanelGemServices.unsafeConnectGems(questionGem,
questionSqlGem.getInputPart(0));
    String questionSQL = null;
    questionSQL = (String) gemServices.runCode(questionSqlGem);
    return questionSQL;
    }
```

To save a MSTO (Gem) created programmatically involves saving the Gem through the workspace into a repository (enterpriseVault) and indicating the specific module where the Gem is to be stored. In order to re-use this Gem in the future the module is included in the workspace that needs access to it.

workspace.saveGem(gemDefinition, moduleName)

Vault vault=getEnterpriseVault(enterpriseSession)

vault.putStoredModule(workspace, moduleName)

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable medium storing executable instructions to define a data modeling system, comprising executable instructions to:
specify named modular semantic transformation objects, each containing a function, a type and metadata; and
combine modular semantic transformation objects, as permitted based on type and metadata constraints, in order to create composite functionality represented by a composite modular semantic transformation object.

2. The computer readable medium of claim 1 wherein said executable instructions to specify named modular semantic transformation objects include functional language code to specify one or more modular semantic transformation objects.

3. The computer readable medium of claim 2 further comprising executable instructions to convert a functional language code modular semantic transformation object to corresponding imperative programming language code.

4. The computer readable medium of claim 3 further comprising executable instructions to process said imperative programming logic code in a managed code platform.

5. The computer readable medium of claim 4 further comprising executable instructions to produce imperative programming language code hosted by a managed code platform selected from Java and .NET.

6. The computer readable medium of claim 1 further comprising executable instructions for strongly typed lazy stateless evaluation of said modular semantic transformation objects.

7. The computer readable medium of claim 1 further comprising executable instructions to inspect and decompose a modular semantic transformation object value by type.

8. The computer readable medium of claim 7 further comprising executable instructions to evaluate the structure of said value and relate said value to user interface components in a registry.

9. The computer readable medium of claim 1 further comprising executable instructions to facilitate access to modular semantic transformation objects using an application program interface.

10. The computer readable medium of claim 1 further comprising executable instructions to specify named modular semantic transformation objects that contain metadata selected from: a category, a hint, a description, use information, history information, a classification, a design and a version.

11. The computer readable medium of claim 1 further comprising executable instructions to present said modular semantic transformation objects in a workspace.

12. The computer readable medium of claim 11 further comprising executable instructions to define an application program interface to access said workspace.

13. The computer readable medium of claim 12 further comprising executable instructions to define a container application to access said application program interface.

14. The computer readable medium of claim 1 further comprising executable instructions to provide modular semantic transform object entity and expression analysis.

15. The computer readable medium of claim 1 further comprising executable instructions to transform modular semantic transform objects into corresponding imperative code existing as a loaded class available to a container application.

16. The computer readable medium of claim 1 further comprising executable instructions to combine a plurality of composite module semantic transformation objects.

17. The computer readable medium of claim 1 further comprising executable instructions to link said composite modular semantic transformation object with a data source, said composite modular semantic transformation object operating on data from said data source to transform said data.

18. The computer readable medium of claim 1 further comprising executable instructions to process said modular semantic transformation objects to produce byte codes.

19. The computer readable medium of claim 1 further comprising executable instructions to facilitate public application program interfaces, including a public application program interface to support at least one of building a modular semantic transformation object, evaluating a modular semantic transformation object, and looking up a modular semantic transformation object.

20. The computer readable medium of claim 1 further comprising executable instructions to define modular semantic transformation objects selected from transient, customized, session, model, and shared modular semantic transformation objects.
